(19) United States
(12) Patent Application Publication
(10) Pub. No.: US 2020/0167870 A1
(43) Pub. Date: May 28, 2020

(54) Method and System Configured for Risk Asset Data Collection

(71) Applicant: INSURDATA CORPORATION, Broomfield, CO (US)

(72) Inventors: Cory Isaacson, Broomfield, CO (US); Tarun Lutrha, Broomfield, CO (US); Jeremy Sterns, Broomfield, CO (US); Jason Williams Futers, London (GB)

(21) Appl. No.: 16/612,939

(22) PCT Filed: May 12, 2018
(86) PCT No.: PCT/US2018/032484

§ 371 Date: Nov. 12, 2019

Related U.S. Application Data
(60) Provisional application No. 62/505,561, filed on May 12, 2017.

(51) Int. Cl. G06Q 40/08; G06Q 50/26; G06Q 10/10; G06Q 20/10; G06Q 20/42; G06Q 50/16; G06F 16/29; H04L 9/06; G06N 20/00

(52) U.S. Cl. CPC G06Q 40/08; G06Q 50/265; G06Q 10/103; G06Q 20/102; H04L 2209/38; G06Q 50/16; G06F 16/29; H04L 9/0637; G06N 20/00; G06Q 20/42

(57) ABSTRACT

Various technological systems and methods are provided related to risk asset analysis, data capture and generating and executing agreements. In one embodiment, for example, a method and system configured for assisting with risk asset data collection is provided. In one implementation, for example, the method and system are configured for accurately collecting detailed information on assets which are subject to risk, including the accurate and unambiguous collection of financial terms of any agreements associated with those assets that all parties have a common and invariable understanding and record of the terms.

### CROSS-REFERENCE TO RELATED APPLICATIONS

This application claims the benefit of U.S. provisional application No. 62/505,561 entitled “Method and System Configured for Risk Asset Data Collection” and filed May 12, 2017, which is hereby incorporated by reference as though fully set forth herein.

### BACKGROUND

### Field

The present disclosure relates to methods and systems configured for risk asset data collection.

### Background

Various types of assets in the world are subject to risk from a variety of perils, including theft, damage, and natural disasters like flood, earthquake, hurricane, etc. Assessment of the risk can be important for a variety of industries and functions in society, including insurance companies, engineering firms, governments, and corporations. These entities need to understand the asset in detail, so that proper evaluation of its exposure to risk and how to perform appropriate mitigation of such exposed risk.

Asset types exposed to risk include a wide variety of items of value, including personal items, jewelry, machinery, automobiles, railway cars, freight shipments, electronic equipment, buildings, and civil structures. In summary, any asset of significant value can be subjected to risk and can be properly evaluated for its exposure and loss potential. Loss or damage to such assets results not only in direct financial loss, but also indirect consequential losses or damage, including interruption of business operations, civil infrastructure, and in extreme cases may put lives at risk.

To plan for and mitigate the effects of such losses requires a detailed understanding of the underlying asset, including specific characteristics that make the asset vulnerable to one or more perils. As an example, shipping of hazardous materials by rail is subject to spills or in some cases explosions in the case of derailment. Buildings are subject to forces from strong winds and storms, flooding, shake from earthquake, fire and other hazards. Due to the wide array of asset types, and the plurality of perils a given asset can be exposed to, many characteristics about a given asset can be understood precisely in order to obtain an accurate assessment.

The asset characteristics required, for a particular situation, vary based on exposure to a given peril. For example, roof structure and materials for a building vary widely in their response to strong winds or rain storms. Another example is a rail freight that could be damaged or subject to leakage or explosion due to train derailment; the vulnerability would vary widely based on the type of material under shipment.

Capturing accurate data about an asset exposed to such risk has been problematic, in that most data is manually entered, is often incomplete and inaccurate. Stakeholders in the process that need to understand the asset in detail for proper risk evaluation have had to resort to data cleansing, data enhancement and validation at each stage in the process. Such processes are limited in effectiveness given incomplete data at inception, they are expensive and time-consuming to perform, and are often repeated by many parties involved in evaluating the risk.

In many cases, such as in the insurance industry, multiple parties evaluate the risk of a single asset or a pool of assets. For example, an insurance broker may collect information from an end-customer on a specific real property (a building); this information is often incomplete as the end-customer is not knowledgeable or expert in the perils or building characteristics that are to be evaluated to understand risk exposure. The broker may attempt to clean up the data (such as an incorrect address), and then pass it on to an insurance carrier to obtain coverage. The insurance carrier, in order to evaluate the risk, may enrich the data it obtains by matching it with other databases including building characteristics like construction type. At some later point the insurance carrier may request reinsurance coverage from one or more companies on a collection or portfolio of such properties, including the above-mentioned property. The insurance carrier may not want to share all of the detailed information it has collected on the property for competitive reasons, and thus, in this situation, the reinsurer must perform significant work of its own to validate, enhance and correct the information on the portfolio of properties. This work is both redundant and inefficient, and results not only in extra cost and work, but also in an inaccurate and variable views of the data on a given asset or assets.

A further aspect to understanding an asset is understanding the financial obligations and agreements associated with the asset. As an example, an asset under shipment will be subject to payment upon arrival, and an inspection may be required prior to issue of such payment. In an insurance or reinsurance example, the financial terms such as deductibles, the limit (maximum payout) of an insurance contract, and perils covered by the insurance agreement should be agreed upon or understood.

Contractual agreements tied to assets are also difficult to manage and track, especially between various parties. The exact terms of such an agreement is usually expressed in language on paper, and transferred by manual input into the various management systems used by each party. This process is error prone, but more importantly the actual precise meaning of such financial terms is subject to both human and system interpretation. As an example, an insurance claim system in one insurance company may differ from that of another in a multi-party insurance or reinsurance transaction. Thus, when an actual claim is submitted, an actual claim from loss may be difficult to settle, leading to inefficiencies, significant time delays and in some cases litigation in a court of law. These same concepts can apply to maintenance agreements for equipment, especially in the case where the equipment is damaged or in a state of disrepair; various parties should understand who is responsible for repair of the equipment asset in such circumstances, what are the expected response times, and what costs are associated with such repair.

### BRIEF SUMMARY

A method and system configured for assisting with risk asset data collection is provided. In one implementation, for example, the method and system are configured for accurately collecting detailed information on assets which are subject to risk, including the accurate and unambiguous collection of financial terms of any agreements associated with those assets that all parties have a common and invariable understanding and record of the terms.

### BRIEF DESCRIPTION OF THE DRAWINGS

FIG. 1 shows an example implementation for an overall process flow.

FIG. 2 illustrates an example geolocation and geocoding process.

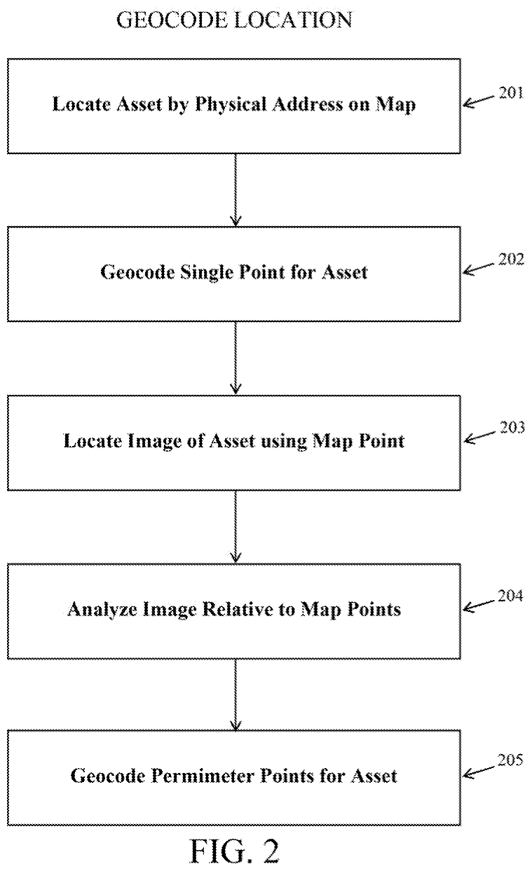

FIG. 3 shows an example preparation of an initial risk score for the asset.

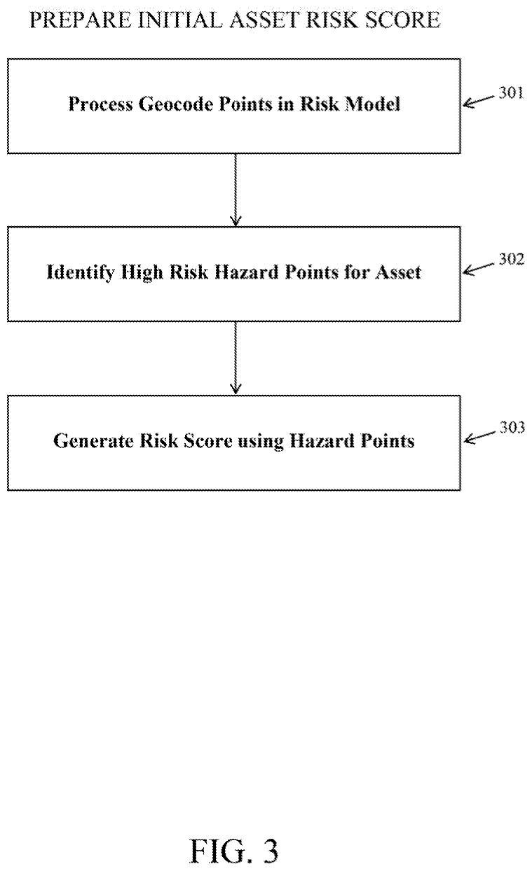

FIG. 4 presents an example detail data collection process for an asset.

FIG. 5 shows an example process for building an asset profile from collected data.

FIG. 6 illustrates an example of a record of an asset profile published to blockchain.

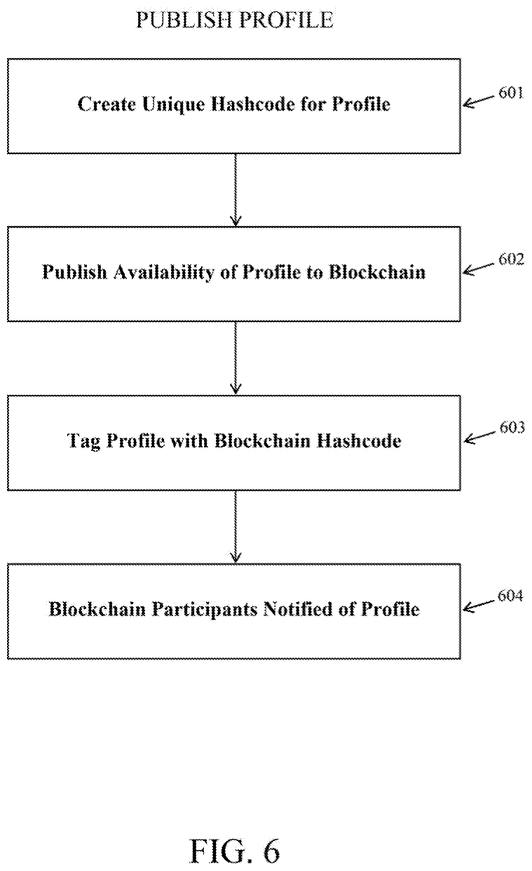

FIG. 7 presents an example process for preparation of a request regarding an asset and releasing an asset profile to select parties.

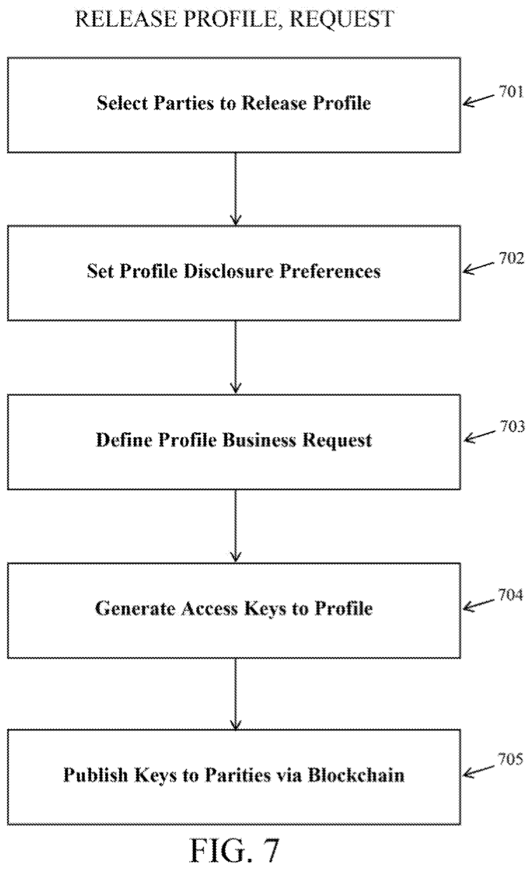

FIG. 8 illustrates an example business transaction using a profile.

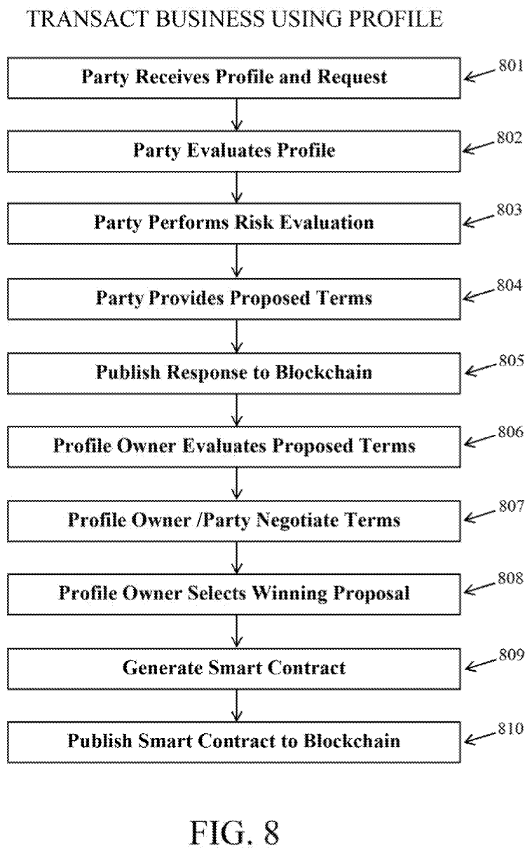

FIG. 9 shows example contract requirements fulfilled and tracked by a system in blockchain.

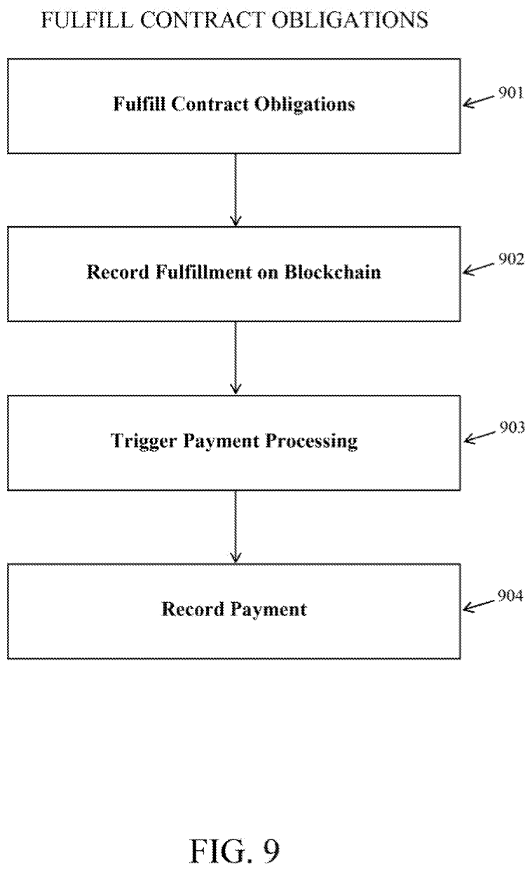

FIG. 10 shows an example implementation of a spreadsheet contract.

FIG. 11 shows an example computing system adapted for use in various process, systems and methods described herein.

### DETAILED DESCRIPTION AND BEST MODE OF IMPLEMENTATION

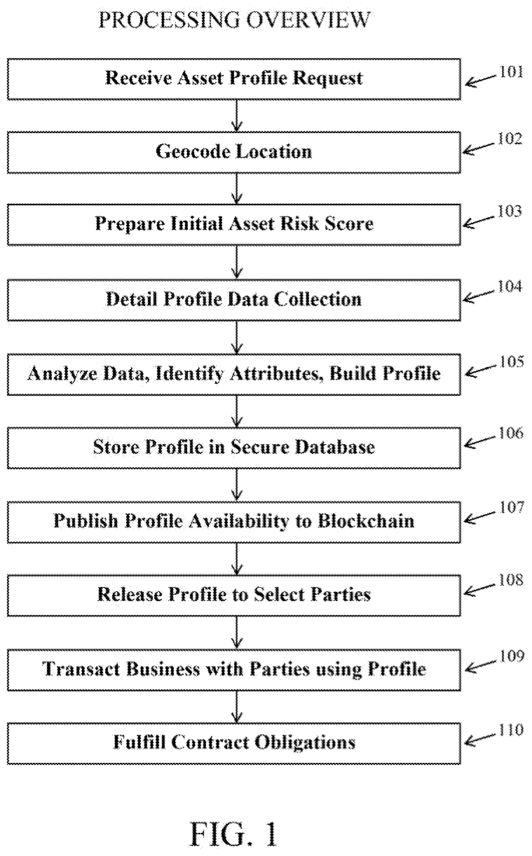

An example summary of process steps in one implementation of a system are shown in FIG. 1.

In this particular implementation, most of the process is described using a real property asset as an example embodiment as this is a common asset requiring extensive risk evaluation, exposed to a plurality of perils and requiring identification of a plurality of associated asset attributes related to one or a plurality of perils in order to evaluate the potential exposure to risk. However, the method and systems provided are designed to function with any type of physical asset that is exposed to risk, the processes and descriptions for real property apply to other asset classes, and other example embodiments are described for amplification of some capabilities of example methods and systems. Further, some of the capabilities of the example methods and systems apply to non-physical assets such as cyber terrorism exposure or human assets as risk exposure for a person.

In a first step, which serves as input to an example system, an asset profile request (101) is received. This, for example, can be via email, portable document format (PDF) or the like, and very often is sent as a schedule (or list) of assets in the form of an electronic spreadsheet using Microsoft Excel or other spreadsheet application. This information can generally be minimal, containing attributes such address, name of the asset owner or other identifying information. Further, the information provided with the request is generally incomplete and often is inaccurate, such as a partial address that can be interpreted by systems or persons in an ambiguous way. Proper identification of the asset is an important step in building a complete asset profile and follow-on contractual agreements about the asset.

Once a request is received, a real property asset is to be physically located to determine its geographic coordinates, a process termed Geocode Location (102). Many asset classes exposed to risk have a specific, primary or changing location that may require geocoding, such as building contents, jewelry, construction equipment, freight trains, trucks, and ships at sea. The first step in geocoding is the location of the asset based on the information provided in the request on an electronic map (201), with a tool such as Google Maps. This process will employ automation by software to find the location using such a tool, can be enhanced (for example in speed and/or in quality) using machine-learning techniques to validate the result, and can also be enhanced by including human expert review of unusual cases and/or for generating accuracy statistics for the automated aspects of the process, as further described below.

The process can be enhanced for quality attainment using a technique called crowd-sourcing, as are many other aspects of the system. Crowd-sourcing is a technique of taking advantage of a large national or global marketplace of individuals that are capable of performing such tasks, such as for a fee or other consideration. There are services available to access such crowd-source marketplaces, and the system described will interact with such systems by submitting required tasks and automatically receiving and evaluating the results of the tasks.

For validation of asset location, a minimum of two junior crowd-source resources, or one expert trained resource, may be used to achieve independent consensus that it is the correct asset location. The results of this crowd-source validation are fed back to a machine-learning model for asset location, and over time improve the model and reduce the requirement for human evaluation. This human-to-model loop can be used for training machine-learning models as an established practice and leveraged throughout the process of the example methods and systems provided. For example, as an embodiment, the accuracy of the process may be efficiently improved on an ongoing basis and this human-to-model loop may be used for training.

Once the asset location is identified, a single point for the real property location may be plotted with its geocode, such as but not limited to in the form of latitude/longitude coordinates (202). The geocode can be used to find an aerial image of the asset (203) on a visual map. There are many existing databases of both satellite and aviation-sourced aerial images for such assets, although custom satellite or aviation-sourced aerial images may be obtained and used.

The image of the asset, once located on a map, can then be analyzed (204) and points around the perimeter plotted (205). In some cases, relevant non-image data may also be found by either commercial or open data sources, where the geocode may be used to find such data and that data may include building geometry data. When available, such data may be used either together with or instead of the perimeter-points data extracted from imagery. In either case, the available imagery and/or non-image data may together be considered ‘additional reference content’ for the geo-coding process. Obtaining coordinates for many points around a real property asset can provide a detailed understanding of its exposure to a plurality of perils, for example to the risk of flood. Flood risk is caused by the movement of water, from excessive rainfall, rivers overflowing or storm surge during violent storms such as hurricane or typhoon. Understanding the movement of water, topographical elevations and the portion of the real property structure impacted by various types of events is important when evaluating the risk. Other perils such as wind have similar characteristics, the path of a given wind storm will impact aspects of the asset in varying ways and from varying angles. Current geocoding processes do not capture this level of granularity of detail for evaluating exposure to risk; rather, the general practice is to find a single geocode for a real property location. In many cases the location is not even within the structure itself. During investigation of existing processes examples have been uncovered where the geocode produced by existing systems placed the location of a real property within a body of water, in the incorrect city (due to a similar address), or at the center of a postal zone. Evaluation of exposure to a one or a plurality of perils for a given asset cannot be properly performed with such erroneous, inaccurate or incomplete data. Some example methods and systems address these problems with geocoding.

After geocoding, an initial asset risk score may be provided against one or a plurality of perils (103). This can be used to show the risk manager what type of exposure(s) the asset is or could be subjected to, and provide an early indication of serious risks that could result in serious financial and related other losses. The results of this step provide input to further stages, directing the development of a detailed asset profile based on relevant perils for the risk asset. For exemplary purposes, some of the peril-specific attributes are: exact building elevation of the first floor (flood), structural reinforcement (earthquake), roof condition (wind), roof material and construction (wind and hurricane), subterranean mechanical systems (flood), building code compliance (general).

To provide an initial assessment of risk to a given peril a catastrophe or other assessment model is used. For a real property asset the model is run on each of the relevant points of the structure perimeter to assess the greatest exposure points (301, 302). This information is input into a risk score calculation engine, computing a risk score by specific peril requested for the asset profile. The initial asset risk score can be provided quickly to the person evaluating the risk, to decide if a full asset profile is required or desirable. Using insurance as an example, an underwriter may learn from the risk score that the specific peril in question is a low-risk hazard, and as a result no further information is needed. Alternatively, the underwriter or risk manager may see warning signs for exposure in the initial asset risk score and will order the full asset profile.

Following the initial asset risk score, detail profile data collection is performed (104). During this step, technology and processes provided in the example implementations may be used to collect the level of granular detail data that may be required for full assessment of the asset's exposure to one or a plurality of perils.

As described above, there are several existing data sources about real property assets available in the form of aerial imagery. This is a top-down evaluation approach, and includes imagery from satellite, aircraft and more recently drones. The information that can be extracted or determined from these sources of imagery is valuable, but cannot provide a full detailed picture of the asset, in particular its exposure to one or a plurality of specific perils. Some of the drawbacks of aerial imagery include: insufficient resolution for accurate measurements (satellite), outdated imagery (satellite, aircraft), and internal contents of the structure (all aerial sources). To develop a complete, accurate and adequate asset profile for risk assessment with a high confidence level, aerial image sources are combined with a bottom-up approach to data collection.

The detail data collection uses a combination of a smart phone application and advanced data collection and analytics. One reason why data collection results in inadequate and poor quality data with existing processes is the lack of expertise among human resources in gathering such data. Example implementations circumvent this by providing a mechanism for data capture of the specific required attributes for a given situation, in such a way as to be performed successfully by a person who is unskilled in the field of risk evaluation or engineering.

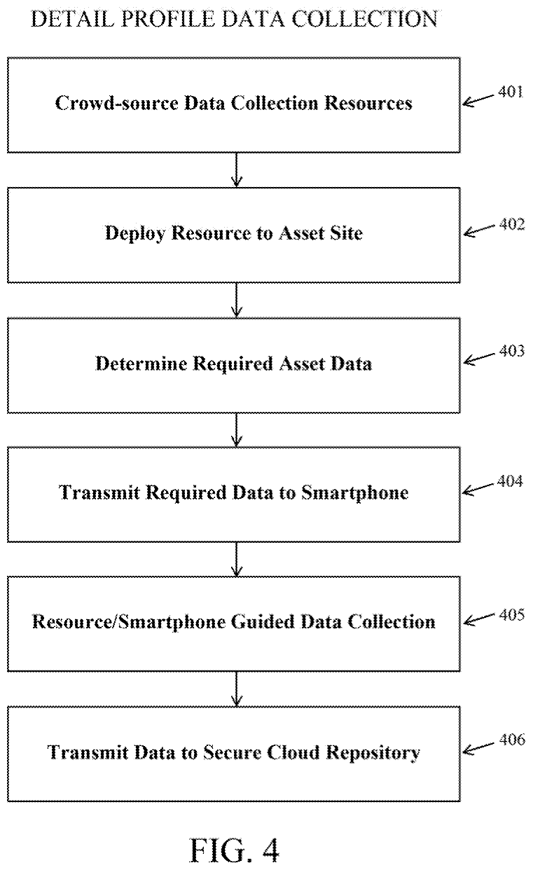

The first step in the example detail data collection process shown in FIG. 4 is the identification of the resource (person) to capture the data (401). This will use crowd-sourcing mechanisms from existing marketplaces, or alternatively the asset owner or a representative of the asset owner can perform the data capture. The detail data capture can also be performed by a professional inspector, although this is not a requirement. Once identified, the resource (person) is deployed to the site of the asset (402). In the case of a real property asset, the person will physically visit the structure; for other assets such as jewelry, equipment or similar items, the resource will need to be present at the physical location of the asset.

Next, the analytics will determine which data and attributes of the asset are to be captured (403); this is termed the attribute selection data. This is dependent on the one or plurality of perils being evaluated for the asset as described earlier. The system evaluates the geocoding data (in the case of an asset with a physical location) and identifies specific aspects of a structure, including external faces and features, the surrounding terrain, and internal elements such as mechanical systems in a building. The system automatically determines the selection data based on the one or plurality of perils to be evaluated. This attribute selection data is then transmitted to the smart phone (404) in the possession of the resource (person) that will perform the detail data collection.

Next the identified resource (person), present at the physical location of the asset, captures the data from the site regarding the asset in a manner guided by the application based on the attribute selection data downloaded to the smart phone (405). In the real property embodiment this is done by several means, including among others, taking digital photographic images of the structure, specific aspects of its façade, its surrounding terrain, specific contents within the structure, walking the perimeter of the structure or a side of the structure. The smart phone device captures additional data with each data element, including the physical geocode of the device and the angle of the device. This, in conjunction with the approximate height of the person capturing the data is used to align with one or a plurality of reference points at the site to situate all data elements captured, and to measure angles, elevations and distances within one inch of accuracy. In another embodiment a portable LIDAR device can be used in place of a smart phone for finer resolution and measurements; such devices are available at low-cost and in the future are expected to be integrated into smart phone devices.

In one implementation, for example, a method or system may utilize techniques such as augmented reality overlays, verbal or written instructions and a map to guide the resource (person) in performing the detail data capture (405). The augmented reality, for example, provides indicators and images that overlay the viewer image of the target, for example a building façade, to guide the resource (person) in capturing the correct needed image. Such an overlay can be used to guide the resource (person) in obtaining the correct aspect, angle and focal distance. Verbal or written instructions are used similarly to guide the resource (person) around the site to the correct locations and data capture targets. Simultaneous to the augmented reality the smart phone collects its geocode location, the date and time, the reference to the attribute selection, the angle of the device and the approximate height of the device from the ground based on the height of the resource (person) as entered into the smart phone application setup before usage. This data is correlated to determine measurements and distances in later steps of the system.

The smart phone application will guide the resource (person) to capture data regarding items or equipment internal to the building or structure, in the case of a real property asset. This information may be required to perform a full evaluation of the risk exposure. One example is the placement of mechanical systems, such as heating and air conditioning equipment that may be located in a subterranean (basement) level. This equipment is both expensive and vital to the function of the building containing the item, and thus is an important part of risk exposure evaluation to the structure as a whole. Capture of items internal to the structure, including their location, is not possible using aerial methods.

Using this approach, a person of ordinary skill without knowledge of engineering or risk evaluation can be successfully guided through the detail data capture in a period of minutes to perhaps one hour given the complexity and size of the asset. Previous methods required a physical inspection by a qualified engineer to obtain information of relevance and accuracy, and one implementation of a method or system may be configured to remove the necessity of such expertise and qualifications. This reduces the cost of accurate asset detail data capture and allows for a high volume of assets to be so processed, given that a person of ordinary skill can perform this function.

Each image captured by the smart phone application is stamped with a verifiable unique key, location, resource (person) identifier and timestamp in addition to the captured information described earlier. This ensures validity and provenance to each image, resulting in a valid, verifiable asset profile later in the process. This feature prevents fraud in the form of manipulating, forging or otherwise falsifying the images.

The images and related capture data are transmitted to a secure repository (406), where they are logged in the blockchain. The term blockchain refers to a distributed ledger technology similar to that of digital currencies such as Bitcoin; this technology is used to create an unalterable, permanent record of each transaction so recorded, along with a unique hash such that it can be verified by multiple parties, and may also include a distributed software execution platform where “smart contract” software may execute. In some implementations, blockchain serves as a record of provenance of all components and data in the resulting asset profile and related contracts.

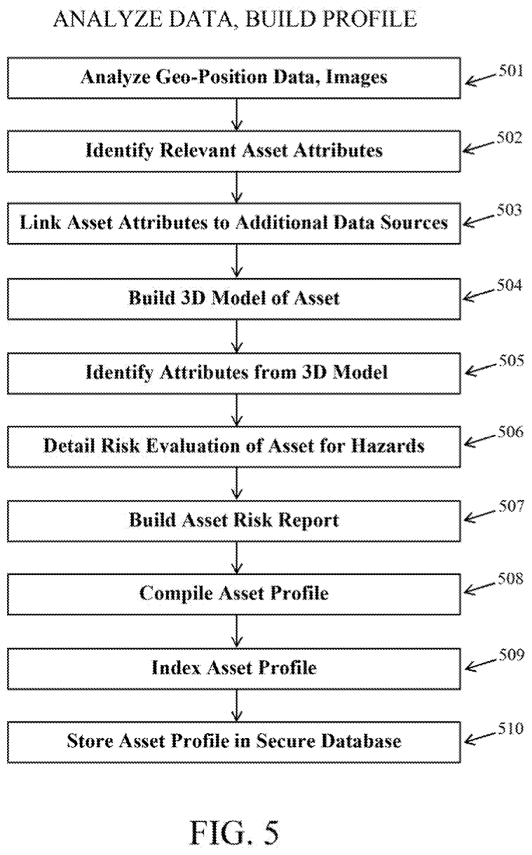

The next step in the system is to analyze the data, identify attributes and build the asset profile (105). In one implementation, for example, the process may include many sub-steps, such as shown in FIG. 5.

The first step in analyzing the data is to identify the geo-position by geocode for each image obtained from the detail data capture step (501). This enables the system to arrange the images into the appropriate positions with reference to the asset being profiled.

Relevant attributes based on one or a plurality of perils under analysis are identified (502). These are the initial attributes identified prior to generation of a 3D model, and include attributes which do not require analysis of the 3D model, such as construction type. The attributes can be linked to additional reference data sources such as building permit reports, property assessor data and aerial imagery (503). Such linked data provides a more complete profile for attributes that cannot easily be captured during the smart phone application image collection at ground-level, for example the type of roof on the structure.

A 3D model is generated for the asset (504), resulting in a measurable model of the asset such as the building structure in one embodiment of methods or systems for real property. A 3D model can be constructed from detail data and optionally other external data sources for any physical asset being analyzed. The 3D model, for example, may be generated from flat imagery, geolocation data, camera angle, and other captured data elements using an existing technique called photogrammetry (https://en.wikipedia.org/wiki/Photogrammetry). Existing software libraries that perform the necessary libraries and functionality to perform 3D model generation are available from commercial and open source sources. The complete 3D model may require inclusion of other image or external data sources regarding the structure, such as the number of stories.

Additional attributes are identified from the 3D model (505), such as accurate measurements, for example elevation of the structure, elevation of the first floor, height of the structure and others. These attributes are categorized by one or a plurality of perils to be evaluated, to determine hazards to the asset (506). In the embodiment for a real property asset, this may include structural elements such as earthquake reinforcement of a brick building or the lack of such reinforcement. This type of information can be gained from the identified asset attributes.

An asset risk report is generated for one or a plurality of perils to be evaluated based on the identified attributes (507) and information gleaned from the evaluation of all data collected about the asset. The asset risk report shows potential exposure to hazards (perils) by the asset, providing such information to the eventual viewer of the report.

The identified attributes and the asset risk report is then compiled into the complete profile of the asset (508), which is then indexed for subsequent search of one or a plurality of asset profiles and data attributes (509). The index is in a form that can be stored in a database for subsequent queries by interested users of the data once the asset profile is published.

The asset profile is then stored, including all image data and identified attributes in a secure database in an encrypted form, such that it can only be accessed and interpreted with a cryptographic key (106, 510).

Once the asset profile is generated and stored, its availability and existence is published to the blockchain of the system (107. At least one unique hash code is generated for the asset (601), ensuring that the provenance and verifiability of the asset can be compared by additional systems that may access the data at a future time which may receive duplicate or transmitted copies of the asset profile, confirming that the asset profile is genuine and matches the original. The availability of the profile is published to the blockchain using this hash code (602). The asset profile is then tagged with this hash code, tying the profile to the record in the blockchain to ensure verifiability and authenticity of the asset profile by systems accessing the asset profile at a future time. Other systems or business parties that are participants in the blockchain are notified of the existence of the asset profile based on an identifier such as a street address, a generated name or a non-specific characteristic such as postal code and type of asset (604). These other systems or business parties cannot access the asset profile at this stage, they are only notified that the asset profile exists.

The asset profile can now be released to select parties (108), such as business parties or external systems. The owner of the profile, or the controlling source system, selects parties to release the profile to (701). Additionally, disclosure profile settings can be determined, specifying what portions of the profile should be published (702). For example, it may be desired to publish a specific set of identified attributes to a party based on their specific authorized use of the profile, and may or may not include imagery contained in the asset profile. For example, if a residential homeowner is publishing the asset profile for their residential structure, they may desire to keep imagery of the structure or its internal contents private. Further, data can be anonymized such that the actual identify of the asset is not disclosed. The asset owner can define a business request, which is the purpose of disclosing the asset profile (703). For example, a request to obtain an evaluation of the asset such as an appraisal or a quote for a specific type of insurance may be requested. A cryptographic key is generated for secure access to the asset profile by the system for each party that shall have access to the profile for a given business request (704). The one or a plurality if keys are published to one or a plurality of parties via the blockchain (705), allowing only the specific parties or systems so authorized access to the asset profile. The parties or systems receive the keys from the blockchain, but only the keys that a specific system or party is to be provided access to the asset profile, including the definition of the portions of the asset profile that should be accessed. Thus the asset profile or a specific portion of the asset profile can be securely transmitted to one or a plurality of external parties or systems in a controlled and verifiable manner.

Business parties are now able to transact business related to the asset profile (109). The asset profile or a collection of asset profiles can be transmitted between parties in a cryptographically secure manner by various means, including file transfer, cloud repository, email or other common mechanism. One or a plurality of receiving parties can receive one or a plurality of asset profiles and associated business requests by common means described above in a secure fashion. This ensures that only parties authorized to receive a given asset profile are able to do so, and such that the receiving party can perform a verification of the asset profile ensuring its authenticity (801). The receiving party may load the asset profile into its own system, or view the profile directly. The receiving party then evaluates the asset profile and associated business request to determine the party's interest in participating in the business opportunity so expressed (802). The receiving party can then proceed to perform its own risk evaluation based on data contained within the asset profile, as in an embodiment for an insurance carrier as the receiving party (803). The risk evaluation is easier to perform and can be performed with a higher degree of accuracy as compared to prior methods, due to the detail, completeness and accuracy of the asset profile.

The receiving party prepares a proposal of business terms in response to the business request (804), sending those terms to the originating (asset profile owner) party via the blockchain of the system (805).

In one example implementation, a proposal is defined in a spreadsheet application such as Microsoft Excel, which defines all or a portion of the financial terms of the proposal. For an insurance proposal example, this could be policy terms including items such as premium amount, limits of coverage, deductibles, and special sub-limits for specific types of risk. A spreadsheet is a universally acceptable business tool, and thus the proposed terms can be defined in a manner that is both unambiguous and comprehensible to the originating party who evaluates the proposal. Further, a spreadsheet can serve as a smart contract function in the blockchain, as described later. Each version of the spreadsheet is transmitted between parties in an encrypted fashion directly over the blockchain or by other common means of exchange, with a verifiable unique hash code, allowing each party to authenticate the proposal and financial terms as valid and unaltered.

The profile owner evaluates the terms of the proposal (806), by viewing the spreadsheet expressing the business financial terms. The parties continue to negotiate by exchanging proposals and counter-proposals until a final agreement is reached or the parties decide not to initiate a formal business transaction (807). The proposal is verifiable by the system as authentic, including its version as sent by the party making the proposal. By using the blockchain of the system, an audit trail is permanently and unalterably preserved of all version of a proposal and counter-proposals in sequence, enabling all parties to verify the negotiation and its outcome in the future for business or legal purposes. The asset profile owner may conduct such negotiations with one or a plurality of business partners in order to obtain the optimum business arrangement.

The asset owner selects a winning business proposal for the transaction, or abandons the transaction if no acceptable proposal was submitted (808). The final winning proposal is converted into a smart contract on the blockchain (809). A smart contract is executable program code or a function that can be executed automatically by the blockchain to perform future transactions with the rules specified in the smart contract based on blockchain records that relate to the smart contract. For example, in the case of an insurance contract a future claim can be recorded in the blockchain and the smart contract will automatically compute the claim amounts to be paid, the claimants to whom the claim funds are owed, and initiate the requisite financial transactions to process the associated payments based on certain agreed triggering conditions having occurred. In a typical embodiment, notification of such triggering conditions are sent by a third-party service, who is previously agreed by contract parties as trustworthy. Payments can be made in standard currencies, or blockchain base crypto currencies can be used, providing a wide degree of flexibility for exchanging value related to such business transactions.

In one implementation, the spreadsheet is automatically converted to executable program code that can be executed on the blockchain in response to future blockchain records that relate to the transaction (809). In an alternative embodiment the spreadsheet can be executed one or a plurality of servers external to the blockchain as a network service, where the spreadsheet definitions are executed as remote functions, either in the native spreadsheet application or in a compiled code representation. In this alternative embodiment, smart contract code is contained in the blockchain to perform the remote invocation of the contract logic and configured to receive the results of the computation, with the same outcome as if the complete smart contract logic were executed on the blockchain. The smart contract is published to the blockchain for future execution upon code generation or in the alternative embodiment the logic required to perform a remote execution of the smart contract as a network service (810).

With other smart contract implementations, it is required that a user define contract terms and functions in a programming language, or that a system interprets user intent into such a function or program code that can be executed on the blockchain. In this implementation, the method or system provides an unambiguous mechanism to perform this process that can be easily understood by a person of ordinary skill without special programming skills, and avoids interpretation and translation of business terms from a user-defined format to a blockchain executable format. Such translation can alter the intent of the user defining the business terms, and as such can lead to ambiguous definitions across systems operated by related parties involved in the business transaction. In this implementation, a method or system can avoid such misunderstanding and interpretation risk by directly invoking the business spreadsheet or a compiled representation of the spreadsheet, exactly as the user that defined the business terms intended, without requiring any special skills or technology layers that interprets the original user's intent.

This method allows additional parties to view the proposal negotiation and contract chain in future downstream transactions, along with the asset profile. For example, a reinsurer may provide reinsurance coverage to the original policy issuer, and can upon authorization see a secure, accurate, verifiable and authentic representation of the asset profile and any related contracts. This mechanism supports any number of parties and any number of transactions performed against one or a plurality of asset profiles by any number of business parties. In the event of a legal dispute relating to a contract, a verifiable unalterable record of the asset profile and contract.

In another implementation, the contract terms may be compiled into program code, optionally using an intermediate meta-language, generating a compiled function according to the rules provided by the user in the Excel spreadsheet. Using this embodiment, the compiled code containing the contract terms can be applied to an applicable scenario to determine the financial result of the terms for the given scenario. For example, when such compiled code represents the financial terms of an insurance policy, the compiled function can be used to calculate the prospective or actual insurance loss or payout resulting from an actual or modeled event. Thus, the compiled function can be applied to data in a database from actual or modeled events. The function can be processed in an efficient manner on one or a plurality of such events on one or a plurality of computing devices, for example data big data cluster.

The final phase of the system is to fulfill contractual obligations as expressed in the blockchain and smart contract (110). The parties can conduct business related to the asset profile and contract, and where a smart contract is published to the blockchain as described such business and related transactions can be automatically carried out. When a party fulfills a contract obligation (901), and the fulfillment is recorded in the blockchain (902). This fulfillment may trigger a payment (903) if a payment is required, and the payment can be automatically processed by the smart contract if applicable. The action of the payment is then recorded (904). Other types of obligations can be recorded in the blockchain and acted upon, including for example distribution of commissions based on a payment or renewal of a contract.

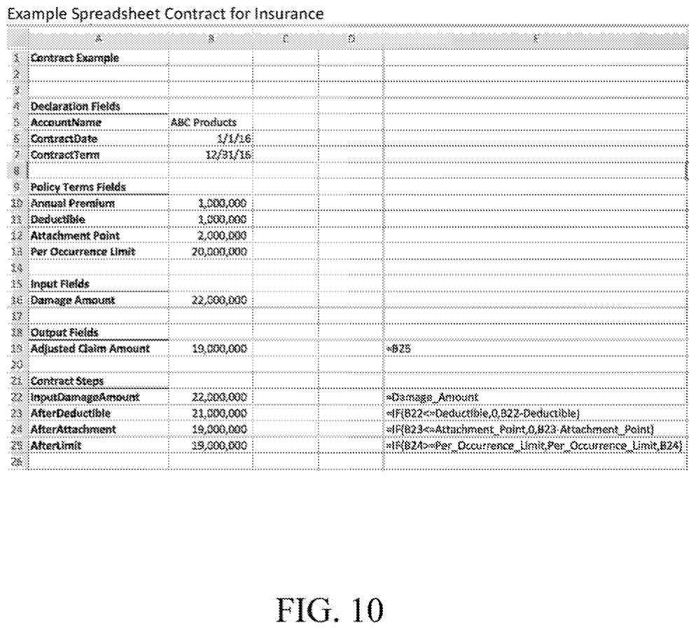

FIG. 10 shows an example implementation of a spreadsheet contract.

### Exemplary Computing System

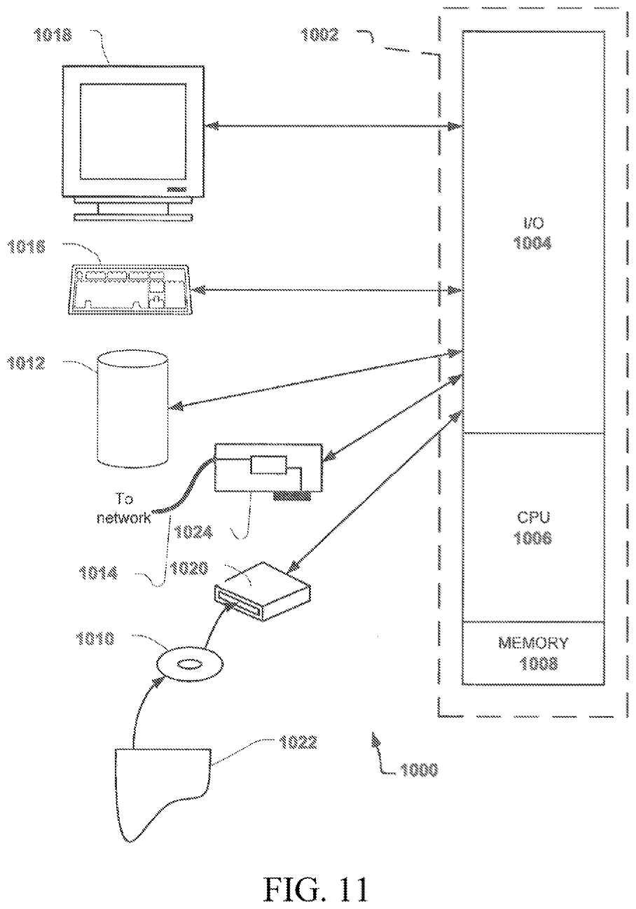

FIG. 11 is a schematic diagram of a computing device 1000 upon which a creatives management or deployment system may be implemented. As discussed herein, implementations include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

FIG. 11 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 11 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 11 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1008, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward operating the subsystems may reside on the disk storage unit 1012, disk drive unit 1020 or other storage medium units coupled to the computer system. Said software instructions may also be executed by CPU 1006.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of a particular computer system. Accordingly, the logical operations making up the embodiments and/or implementations described herein are referred to variously as operations, steps, objects, or modules. Furthermore, it should be understood that logical operations may be performed in any order, unless explicitly claimed otherwise or a specific order is inherently necessitated by the claim language.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of the computer system being used. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

In some implementations, articles of manufacture are provided as computer program products. One implementation of a computer program product provides a transitory or non-transitory computer program storage medium readable by a computer system and encoding a computer program. Another implementation of a computer program product may be provided in a computer data signal embodied in a carrier wave by a computing system and encoding the computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A process of capturing data for a remote location via a portable electronic device comprising:
on one or more servers:
determining a remote location of an asset using a processor;
determining one or more peril to evaluate based at least in part on the remote location of the asset; and
computing one or more category of data capture based at least in part on the remote location or the peril;
on the portable electronic device:
downloading data to an application executing on a processor of the portable electronic device; and
providing instructions to a user on the portable electronic device to assist in the data capture via the portable electronic device.

2. The process of capturing data of claim 1 wherein the data capture comprises at least one of an image and text captured via the remote computing device.

3. The process of capturing data of claim 1 wherein the instructions comprise at least one of verbal instruction, written instruction, guidance via a map, an image.

4. The process of capturing data of claim 1 wherein the portable electronic device comprises at least one of a smartphone, a tablet, and a laptop computer.

5. The process of collecting data of claim 1 wherein the instructions provide augmented reality to validate a target for the data capture.

6. The process of capturing data of claim 5 wherein the augmented reality comprises at least one of a pointing device, an arrow, a highlight, a color intonation, a circle, a rectangle, a polygon, a computer-generated overlay image that can fulfill the purpose of indicating to the user of the portable electronic device where to look or what action to complete.

7. The process of capturing data of claim 1 further comprising capturing data via the portable electronic device.

8. The process of capturing data of claim 1 wherein the captured date is transmitted to the one or more servers from the portable electronic device.

9. The process of capturing data of claim 8 wherein the captured date is used to evaluate a risk of the one or more peril at the remote location.

10. A process comprising:
creating one or more financial terms in a spreadsheet, forming a proposal or agreement;
transmitting the spreadsheet to one or more other party for review; and
automatically computing using the spreadsheet as a function,
wherein the spreadsheet is adapted to be converted to executable code or can be executed in a service.

11. The process of claim 10 wherein the process is configured to use a compiled function or spreadsheet against data in a database.

12. The process of claim 10 wherein the spreadsheet is human readable and adapted to be interpreted by a person.

13. The process of claim 10 wherein the spreadsheet is compiled into a blockchain smart contract function.

14. A process for locating an asset comprising:
locating an asset by a physical address on a map;
geocoding at least one point for the asset;
locating an additional reference content item pertaining to the asset using a map point;
analyzing the additional reference content item relative to at least one map point; and
geocoding a plurality of perimeter points for the asset.

15. The process of claim 14 wherein the additional reference content item comprises one or more images.

16. The process of claim 14 wherein the additional reference content item comprises machine-readable data.

17. The process of claim 16 wherein the machine readable data describes building geometry.

18. The process of claim 14 wherein the process further comprises:
processing the geocode points in a risk model;
identifying at least one risk hazard point for the asset; and
generating a risk score using the at least one risk hazard point.

19. The process of claim 14 wherein the process further comprises:
processing the geocode points in a risk model;
identifying at least one risk hazard point for the asset; and
generating a model damage risk assessment using the at least one risk hazard point.

20. A process of generating a data model for an asset, the method comprising:
identifying at least one asset attribute for the asset;
identifying at least one attribute of the asset;
categorizing the at least one attribute of the asset by at least one peril to be evaluated;
generate at least one risk evaluation of the asset for at least one peril based at least upon the identified at least one asset attribute; and

21. The process of claim 20 wherein the process comprises obtaining a geo-position for a plurality of data elements related to the asset.

22. The process of claim 21 wherein the plurality of data elements comprise at least one image of the asset.

23. The process of claim 21 wherein the geo-position comprises a geocode for the data element.

24. The process of claim 23 wherein the geo-position comprises a geocode for the data element relative to the asset.

25. The process of claim 20 wherein at least one asset attribute is linked to a reference data source.

26. The process of claim 25 wherein the reference data source comprises an external reference data source.

27. The process of claim 20 further comprising generating a three-dimensional model of the asset.

28. The process of claim 27 wherein the at least one attribute of the asset is identified from the three-dimensional model.

29. The process of claim 28 wherein the three-dimensional model of the asset comprises a source of a plurality of attributes of the asset.

30. The process of claim 20 wherein the process comprises generating a profile of the asset.

31. The process of claim 30 wherein the profile of the asset is indexed for subsequent search of at least one asset profile and data attribute.

32. The process of claim 31 wherein the index is stored in a database for subsequent queries.

33. The process of claim 32 wherein the process comprises generating a unique hashcode for the profile.

34. The process of claim 33 further comprising publishing the availability of the profile to blockchain.

35. The process of claim 34 further comprising tagging the profile with the blockchain hashcode.

36. The process of claim 35 further comprising notifying at least one blockchain participant of the profile.

37. The process of claim 34 further comprising selecting at least one party to release the profile.

38. The process of claim 37 further comprising setting at least one profile disclosure preference.

39. The process of claim 38 further comprising defining a profile business request

40. The process of claim 39 further comprising generating access to at least one encryption key to the profile.

41. The process of claim 38 further comprising publishing the at least one key to parties via blockchain.

42. A process for generating a contract via blockchain, the process comprising:
receiving, at a first computing device associated with a first party, a profile of a second party and a request;
receiving a plurality of terms from the first party at the computing device associated with the first party;
publishing the plurality of terms to blockchain;
receiving the plurality terms via blockchain at a second computing device associated with the second party;
accepting or declining at least one of the plurality of terms;
when at least one of the plurality of terms is declined, modifying the plurality of terms to include at least one counter-term and returning a revised plurality of terms including the at least one counter-term to the first computing device for review;
generating a smart contract based on the accepted or declined terms; and
publishing the smart contract to blockchain.

43. The process of claim 42 wherein the process comprises conducting at least one negotiation related to the plurality of terms via the first and second computing devices prior to acceptance of the at least one of the plurality of terms.

44. A process administering a contract via blockchain, the process comprising:
recording an occurrence of at least one contract condition on blockchain;
executing automated rules comprising at least one contract obligation pertaining to at least one contract condition;
recording fulfillment of at least one contract obligation on blockchain;
triggering payment processing based on the fulfillment; and
recording the payment on blockchain.

45. The process of claim 44 wherein the process begins automatically by the blockchain receiving notification from a third-party of an event having occurred for which the contract contains conditions regarding payment processing.

46. The process of claim 45 wherein the third-party is previously agreed by parties to the contract as a party whose data and notification process will be a trusted authority upon which contract fulfillment decisions may be based.

47. The process of claim 44 wherein the process is semi-automated, and rather than payment processing being triggered automatically, instead the process provides for a person to review and approve or reject the proposed payment before processing occurs.

48. A system comprising at least one processor adapted to perform any of the processes recited in all or a portion of any of claims 1-47.
